(19) United States
(12) Patent Application Publication
(10) Pub. No.: US 2008/0167796 A1
(43) Pub. Date: Jul. 10, 2008

(54) NAVIGATIONAL REFERENCE LOCATION DETERMINATION USING REVERSE LOOKUP LOCATION IDENTIFIER

(75) Inventor: Chandrasekhar Narayanaswami, Wilton, CT (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/620,736

(22) Filed: Jan. 8, 2007

(51) Int. Cl. G01C 21/00; G06F 17/30

(52) U.S. Cl. 701/200

(57) ABSTRACT

This embodiment of the invention relates to a navigational system having at least navigational software capable of determining and or displaying maps, directions, and or for providing other location specific information. The navigational system is capable of accepting location identifier data. Such location identifier data can include a phone number, caller ID, an email address, an instant message address, and or other types and or kinds of location identifier data. In response, the navigational system performs a reverse lookup query using the location identifier data to determine the location street address, and or other location specific information. This location street address, and or other location specific information are then used to provide maps, directions, and other location information to a user by way of the navigational system. The navigational system can obtain information from local data processing resources, and or optionally from remote global network based data processing resources.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

An embodiment of the invention relates to a navigational system having at least navigational software capable of determining and or displaying maps, directions, and or for providing other location specific information. More particularly, this embodiment of the invention relates to a navigational system capable of accepting location identifier data. Such location identifier data can include a phone number, caller ID, an email address, an instant message address, and or other types and or kinds of location identifier data. In response, the navigational system performs a reverse lookup using the location identifier data to determine the locations address (also referred to as street address or geographical reference point), and or other location specific information. The location street address, and or other location specific information are then used to provide maps, directions, and other location information to a user by way of the navigational system.

2. Description of Background

Several mid to high-end automotives include navigation systems. However, they fail to provide a simple way to enter destination addresses. Current methods present users with an onscreen keyboard to enter street names and numbers or ask the user to choose form a long list of menus and options. A simple mechanism to provide addresses for destinations is needed.

Currently, users can obtain directions for going from one place to another by entering the address for a start location and a destination location. This method is available on many internet map and direction websites, is an option with many navigational systems, and a feature in many of the handheld navigation systems. However, entering addresses is sometimes difficult for a few reasons. First it may be cumbersome to enter long addresses in systems that have constrained input capabilities such as small keyboards, awkward touch screens, or no standard data entry controls to name a few. This is often the case for many of the handheld and in-vehicle systems.

In addition, once a user takes the time to enter an address often the actual address may not be available, many similar address are returned, or discrepancies in the formatting of the location number or street name result in the navigation system being unable to locate the correct location.

Some systems allow map-based input of start and destination locations but this requires zooming into the map at the right resolution and selecting the start location, then zooming out and moving to the destination region and then zooming back in and selecting the destination location.

Though zooming in and trying to pin point a start or destination location may seem intuitive it is problematic when your start or destination are not landmarks and don't appear on the map, such can be the case for many regular addresses. In some navigation systems a user may be able to jump to a particular location on a map by supplying latitude and longitude but this method can also be cumbersome and very non-intuitive.

### SUMMARY OF THE INVENTION

The shortcomings of the prior art are overcome and additional advantages are provided through the provision of a method of entering location identifier data into a navigational system to be used in a reverse lookup process to determine location specific information (also referred to as location specific data, location street address, and or geographical reference point). Such location specific information can include a street address or other information that can be utilized by a navigational system to determine and or display maps, directions, and or other location specific information.

An embodiment of the invention relates to a method of determining a navigational reference location. The method comprising the steps of entering or sending a plurality of location identifier data into a navigational system; performing a reverse lookup query with the plurality of location identifier data to obtain a plurality of location specific data, the plurality of location specific data is a geographical reference point on a map or used to determine directions to a destination location; and displaying the plurality of location specific data on the navigational system display.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution, which allows location specific information, and other navigational reference data to be obtained and displayed on a navigational system more easily and quickly. In this regard, more intuitive data such as a phone number, email address, caller ID, instant message address, and other location identifier data can be used in a reverse lookup process to obtain location specific data such as a location street address. This method is in lieu of try to perfect the manual entry of a complete location street address into a navigation system to generate navigational and other reference data. The method of the embodiment of invention results in faster and more accurate determination of navigational reference points, and as such makes navigational systems quicker and easier to use.

### BRIEF DESCRIPTION OF THE DRAWINGS

The subject matter, which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a plurality of portable data processing devices and a vehicle 306 equipped with a navigational system 500 utilizing location identifier data in a reverse lookup process to provide navigational maps 304 and or directions 302;

FIG. 2A illustrates one example of a navigational system 500 block diagram;

FIG. 2B illustrates one example of an in vehicle system 500 block diagram;

FIG. 3A illustrates one example of a navigational device system 500 data communication with a plurality of other data processing devices;

FIG. 3B illustrates one example of a navigational device system 500 data communication locally and or over a global network 210 with a plurality of other data processing devices;

FIG. 4A illustrates one example of a user supplying location identifier data to query location specific information;

FIG. 4B illustrates one example of a data processing device supplying location identifier data to query location specific information;

FIG. 4C illustrates one example of a data processing device supplying location identifier data to query location specific information, the query being performed at a global network based data processing resource; and

FIG. 4D illustrates one example of a navigational system 500 querying location specific information to be displayed, and or presented to a user.

The detailed description explains the preferred embodiments of the invention, together with advantages and features, by way of example with reference to the drawings.

### DETAILED DESCRIPTION OF THE INVENTION

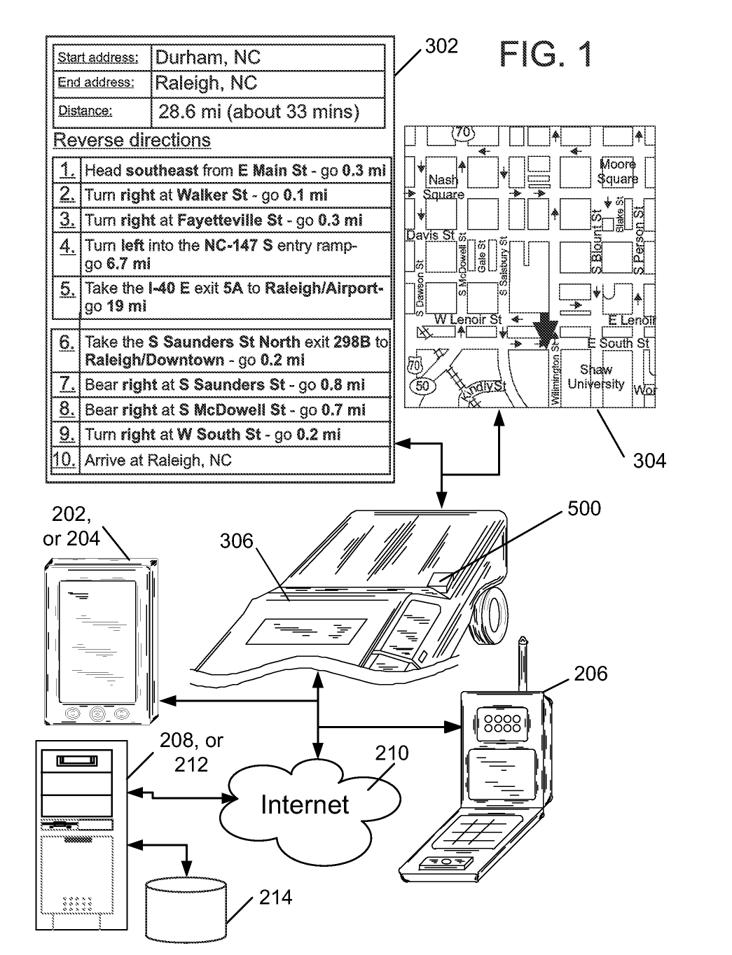

Turning now to the drawings in greater detail, it will be seen that in FIG. 1 there is one example of a plurality of portable data processing devices and a vehicle 306 equipped with a navigational system 500 utilizing location identifier data in a reverse lookup process to provide navigational maps 304, and or directions 302.

In this regard, a plurality of data processing devices 202, 204, 206, 208, and or 212, and a navigational system 500 utilize location identifier data such as a phone number, caller ID, email address, instant message address, or other location identifier data to perform a reverse lookup query resulting in obtaining and displaying more detailed location specific information.

In an exemplary embodiment, a user can manually enter the location identifier data into the navigational system 500, and or the location identifier can be data communicated from other data processing devices locally and or remotely, including from global network based data processing resources. Once queried the location specific information such as maps 304, and directions 302, as well as other location specific information can be presented to the user by way of the navigational system 500 display options.

In an exemplary embodiment a user can enter a phone number, caller ID, email address, instant message address, or other location identifier data into the navigational system 500 (also referred to as system 500). In this regard, the system 500 can utilize the location identifier data provided in a reverse lookup process to obtain location specific information such as the street address or geographical reference point associated with the location identifier data.

As an example and not limitation, a user can enter the phone number of a restaurant or theater into the system 500. The system 500 can then based in part on the phone number supplied obtain location specific information such as the street address of the restaurant or theater. Such location specific information may include generating map 304 showing the location of the restaurant or theater, directions 302 showing how to get to the restaurant or theater, and or other location specific information. Optionally the user could have supplied different location identifier data such as an email address, or an instant message address, or other types and or kinds of location identifier data.

In an exemplary embodiment, the location specific information may be displayed on the navigational system 500 display, and or data communicated to other data processing devices. Such other data processing devices may include, for example and not limitation, the user's wireless phone 206, or personal data assistant (PDA) 204, a personal computer (PC) 208, global network based data processing resources 212, and or include other types and kinds of data processing devices 202. Such wireless phones 206 can include those supplied by and or manufactured by Samsung, LG, Motorola, Nokia, Nextel, Sprint, Cingular, AT&T, and or other types and kinds of similar and or suitable wireless phones. A personal computer 208 can be a laptop, pocket PC, desktop, server, or other types and kinds of similar and or suitable personal computers.

Additionally, in a plurality of exemplary embodiments the navigational system 500 can be configured to utilize local database storage, removable storage medium, access data by way of a global network 210, access personal computers 208, and or data communicate with global network based data processing resource 212 from a plurality of global network based data processing resources.

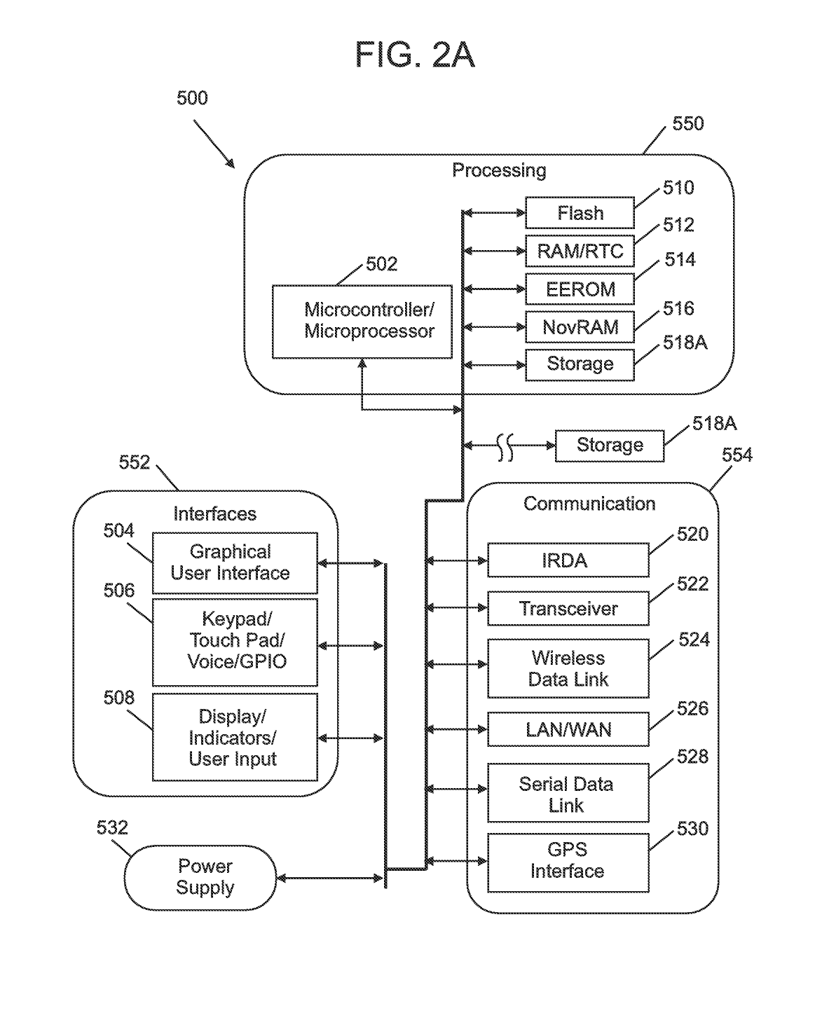

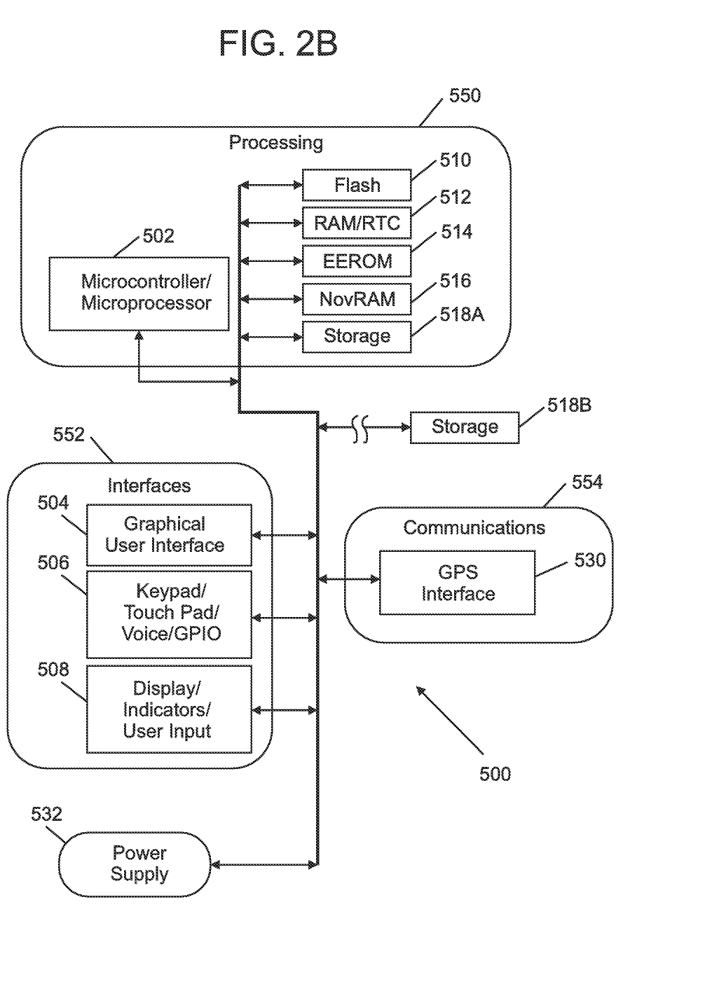

Referring to FIG. 2A there is illustrated one example of a navigational system 500 block diagram. The navigational system 500 can include a processing section 550, an interface section 552, and or a communication section/devices 554. A power supply 532 can include alternating current (AC), direct current (DC), batteries, chemical, solar cells, and or other similar or suitable power supplies as may be required or desired in the embodiment.

Interconnected with a microcontroller 502 can be flash memory 510, random access memory (RAM) and or optionally a real time clock (RTC) 512, electrically erasable read only memory (EEROM) 514, non-volatile random access memory (NOVRAM) 516, and removable, detachable, and or changeable storage medium 518A, and 518B. Such storage medium 518A-B can include as an example and not a limitation CDROM, compact flash, and other types and kinds of removable and or changeable storage medium.

In addition, a graphical user input interface 504 can be interconnected with a microcontroller 502. The graphical user interface 504 can allow a user to view, change, program, and or otherwise interact with the navigational system 500. In an exemplary embodiment microcontroller 502 can be an INTEL X-scale, strong arm, PENTIUM, x86, MICROCHIP, AMD, ZILOG, MOTOROLA POWERPC, 68 HC, ARM, HITACHI, RABBIT, SANYO, and or other similar, or suitable microcontroller. A microprocessor can be referred to as a microcontroller, and or microcontroller 502. Microcontroller 502 can also incorporate memory. Such memory can include read only memory (ROM), random access memory (RAM), real time clock (RTC), flash memory, Serial I2C flash memory, and or other types, kinds, similar, and or suitable memory.

Furthermore, a navigational system 500 can operate on an embedded binary input-output system (BIOS) including a personal computer (PC) BIOS and can run embedded system operating systems. Embedded system operating systems (OS) can include OSEK, OSEK/VDX, PALM OS, LINUX, WINDOWS 9x, WIND RIVER, WINDOWS 2000, WINDOWS CE, WINDOWS CE.NET, XP, NT, embedded NT, MIRA, QNX NEUTRINO, OTI's J9, and other embedded system operating systems. In addition, development tools and application software can include MICROSOFT VISUAL STUDIO development tools, assemblers, C language compilers, cross-assemblers, VIRTUAL JAVA MACHINE (JVM) development tools and application software, and other development tools and application software.

Interconnected with microcontroller 502 can be a keypad/touch pad/voice input/general purpose input output (GPIO) 506. A keypad/touch pad/voice input/general purpose input output (GPIO) 506 can include push buttons, switches, momentary push buttons, digital inputs and outputs, microphones, voice processing and or voice input circuits, analog inputs and outputs, and timers to govern the activation, control, monitoring, data input, and or indications of certain conditions or statuses of the navigational system 500.

Interconnected with microcontroller 502 can be a display/indicator interface/user input 508. A display/indicator/user input interface 508 can include a plurality of user displays and indicators. Such display/indicator interface/user input 508 can include a variety of user feedback devices. Such user feedback devices can include liquid crystal display (LCD), light emitting diodes (LED), organic light emitting diodes (OLED), polymer light emitting electrochemical cells (LECs), pushbuttons, keypads, touch screens, general purpose input/output (GPIO), biometric, and or other similar, suitable, required, and or desired user display/indicator/user input interface devices.

Also interconnected with a microcontroller 502 can be a plurality of data communication interfaces. Such plurality of data communication interfaces can include an infrared (IRDA) interface 520, a transceiver 522, a wireless data link 524, a local area network interface (LAN)/wide area network (WAN) interface 526, a serial data link 528, and or a global position system (GPS) interface 530. The local area network interface (LAN)/wide area network (WAN) interface 534 can include wireless LAN and WAN implementations. The GPS interface 530 can include an interface to standard GPS modules such as those supplied or manufactured by Garmin, Navtech, and Magellan, and or types and kinds of GPS module suppliers and or manufacturers. In an exemplary embodiment the GPS interface 530 can also include GPS device technology incorporated into the overall system design of the navigational system 500.

The plurality of data communication interface (520, 522, 524, 526, 528, and 530) can include a plurality of devices and interfaces to effect data communication with other data communicating and or data processing resources. Such devices and interfaces can include wired and wireless wide area networking (WAN) and local area networking (LAN) data communications and interfaces. Such information technology standards can include for example and not limitation those developed by organizations such as IETF, WC3, Oasis, ISO, IED, and or ITU. Such WAN and LAN data communications can be by way of proprietary wireless standards and protocols, Institute of Electronics Engineers (IEEE) wireless protocols and standards, ETHERNET, FIREWIRE, AEROCOM, L3, 3COM devices, wireless standards and protocols, MOTIENT DATATAC networks, VERIZON networks, CINGULAR networks, SPRINT networks, AT&T networks, SIERRA WIRELESS devices, MULTI-TECH device, WAVECOM device, a WISMO device, wireless standards, and protocols wireless application protocol (WAP), CDPD, PCS, WCDMA, TDMA, TDD, GSM, 1XRTT, CDMA, CDMA 2000, GSM, 1X 3G, general packet radio service (GPRS), enhanced data rates for global evolution (EDGE), TDMA, 2G/2.5G type communication (‘G’ is an abbreviation for generation—for example, 2G is second generation technologies), 3G and 4G type communication, infrared data communication (IRDA), IEEE 802.11‘x’ (‘x’ meaning all types and kinds of 802.11 standards and protocols including ‘a’, ‘b’, and ‘g’), WI-FI, INTEL PRO/WIRELESS 5000 LAN, BLUE TOOTH compliant standards and protocols, small device microwave, spread spectrum, 2.4 GHZ, 5 GHZ, 900 MHZ, 433 MHZ, a single frequency transceiver, a dual frequency transceiver, internet service provider (ISP), a TCP/IP connection, a PPP, SLIP, or SOCKET layer connection, a RAS connection, by utilizing wireless internet standards or protocols, or other internet connection points or connection types or other suitable wireless standards, frequencies, or protocols. Other wired data communications can include serial, CMOS, TTL, RS232, RS422, and RS485 communications as well as universal serial bus (USB) and or other similar or suitable types and kinds of data communication interfaces.

Data communication between the system 500 in a wired and or wireless manner can be effectuated with other data processing devices such as personal computer (PC) 208, personal data assistant (PDA) 204 (also referred to as a PALM device or POCKET PC), a wireless phone 206, data processing device 202, a global network based data processing resource 212, and or other microprocessor based systems and can enable data to be exchanged between the system 500 and or local or remote data processing resources. Such data communications can include software applications to be run by the navigational system 500, data processing tasks that can improve navigational system 500 operations and or functionality, external data processing device operations and or functionality, and or other similar, suitable, desired, and or required data processing activities.

In a plurality of different embodiments, the system 500 can be tailored to include or exclude certain features. In this regard, for example and not a limitation, if a transceiver 522 is not required for a particular embodiment then the system 500 can be manufactured without the transceiver 522 feature.

Referring to FIG. 2B there is illustrated one example of a navigational system 500 block diagram. In this exemplary embodiment the navigational system 500 has less than all the features of the embodiment shown in FIG. 2A. The navigational system 500 has been optimized to use navigation and map data contained on storage medium 518A-B, and GPS data obtained from GPS interface 530. This particular exemplary embodiment focuses on a minimal subset of features to implement a system 500. Referring to FIG. 2B there is shown a system 500 having a power supply 532, and a microcontroller 502, memory and storage 510, 512, 514, 516, and 518A-B, user interfaces 504, 506, and 508, and GPS interface 530.

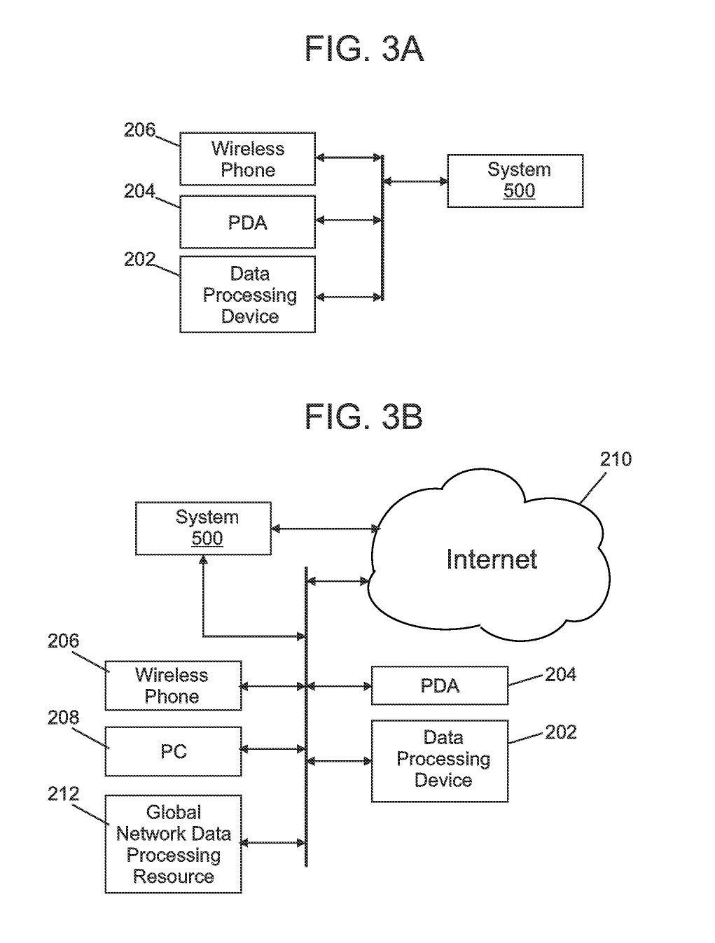

Referring to FIG. 3A there is illustrated one example of a navigational device system 500 data communication with a plurality of other data processing devices. In an exemplary embodiment, in addition to a user interacting with the navigational system 500 by way of interfaces 552, data processing devices local to the navigational system 500 can also provide data and command information. In this regard, location identifier data such as a telephone number, an email address, an instant message address, and or other identifier data can be data communicated to the navigational system 500 by way of a plurality of different types and kinds of data processing devices. Such data processing devices can include for example and not limitation wireless phone 206, PDA 204, data processing device 202, and or other similar, suitable, desirable, and or required types and kinds of data processing devices.

In this regard, information accessible by, displayed on, or otherwise contained in the navigational system 500 can be transferred to a data processing device such as wireless phone 206, PDA 204, data processing device 202, and or other similar, suitable, desirable, and or required types and kinds of data processing devices. If for example and not limitation, the user provides as location identifying data a phone number of a restaurant the system 500 can query a map 304, directions 302, and or other location specific information about the restaurant. The queried location specific information can then be transferred to the users wireless phone 206, PDA 204, or other data processing device. This can enable the user to move the information from the navigational system 500 to a portable device where the information can then be carried by the user and used away from the vehicle at anytime.

Referring to FIG. 3B there is illustrated one example of a navigational device system 500 data communication locally and or over a global network 210 with a plurality of other data processing devices. In this exemplary embodiment a plurality of data processing devices, and a navigational system 500 can data communicate over a global network 210. A global network 210 can also be referred to as the internet 210. In this embodiment, data processing devices such as data processing device 202, PDA 204, wireless phone 206, PC 208, and global network based data processing resource 212 can data communicate with the navigational system 500 locally, and or over a global network 210.

In an exemplary embodiment for example and not limitation a restaurant can email or instant message identifying data to the navigational system 500. The system 500 can then query maps 304, directions 302, and or other location specific information. The user may optionally then transfer the location specific information from the system 500 to the user's wireless phone 206, or other data processing devices.

Alternatively the user or another person may choose to email or instant message location identifier data to the navigational system 500. Such data communication may originate when a user visits a website, and enters his or her navigational system 500 identifier address at the website. The website may then send to the navigational system 500 location identifier data such as a phone number, email address, instant message address, a physical street address, and or other identifier data. The navigational system 500 can then perform the reverse lookup querying maps 304, directions 302, and or other location specific information. The location specific information can then be displayed and or presented to the user of the navigational system 500.

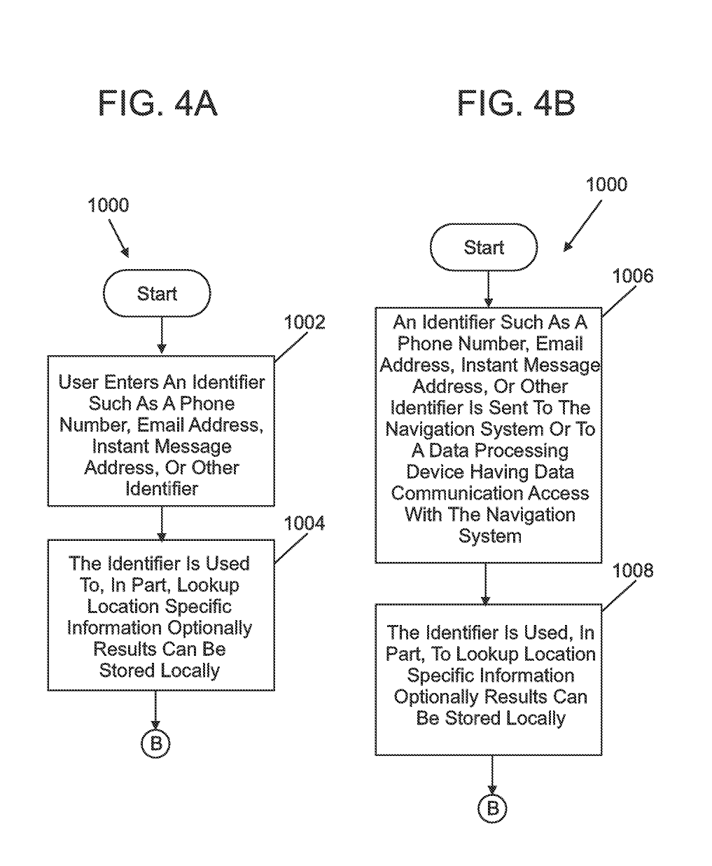

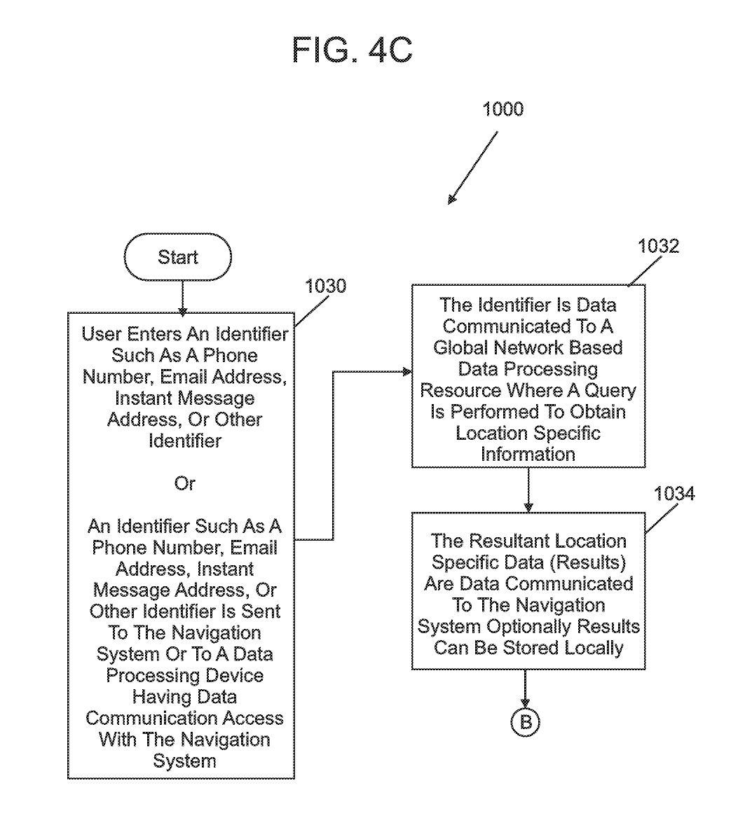

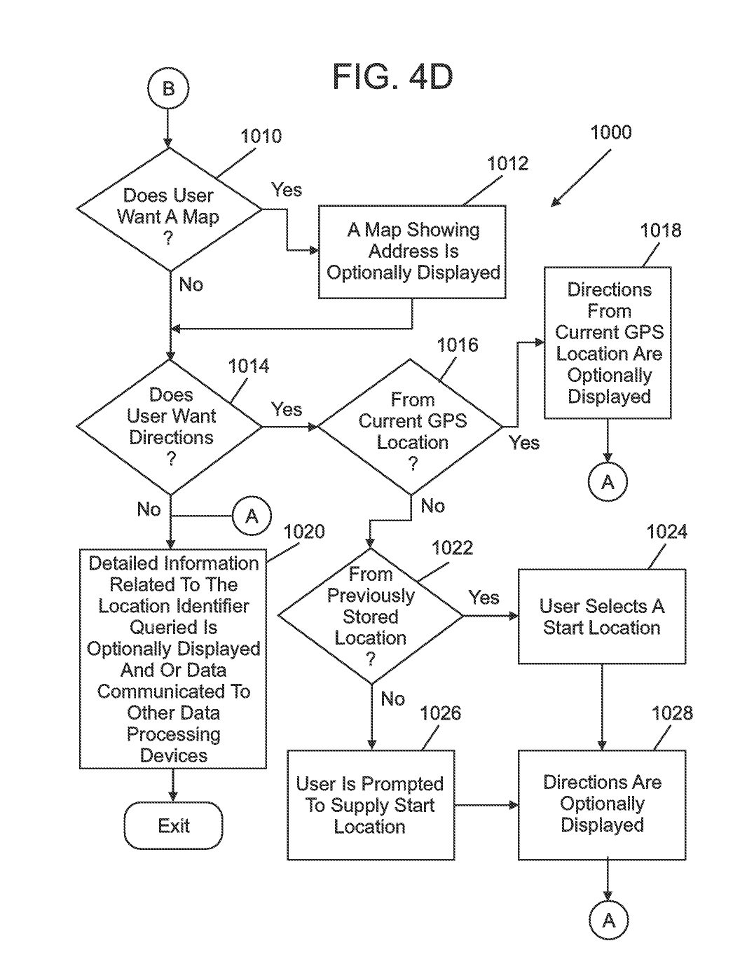

Referring to FIG. 4A there is illustrated one example of a user supplying location identifier data to query location specific information. In an exemplary embodiment a user can enter manually or by way of data communication location identifier data. Such location identifier data can include for example and not limitation a phone number, an email address, an instant message address, and or other types and or kinds of location identifier data. The navigational system 500 can then use the provided location identifier data in a reverse lookup process to obtain location specific information. Such location specific information can include maps 304, directions 302, location street address, a location geographical reference point, and or other types and kinds of location specific information. Processing begins in block 1002.

In block 1002 the user enters manually or by way of data communication location identifier data (also referred to as identifier data, or an identifier). Processing then moves to block 1004.

In block 1004 the location identifier data is used in part to perform a reverse lookup to obtain location specific information. The reverse lookup can utilize locally stored data, data on storage medium accessible by the navigational system 500 and or data remotely located accessible by way of a WAN, LAN, or other type of network connection. Such reverse lookup query can include accessing global network based data processing resources. Location specific information can also be referred to as location specific data, street address, and or geographical reference point. Processing then moves to decision block 1010 shown in FIG. 4D.

Referring to FIG. 4B there is illustrated one example of a data processing device supplying location identifier data to query location specific information. In another exemplary embodiment the location identifier data can be provided to the navigational system 500 by way of data communication from someone other then the user.

To better clarify, in FIG. 4A the user provided the location identifier data to the system 500. In FIG. 4B the navigational system 500 is provided the location identifier data by some other means then by user input.

As an example and not a limitation, a user may call a restaurant to ask about directions. The restaurant employee may ask the user for his navigational system 500 address or ID. The user provides the system 500 address or ID (which may be the email address of the navigational system 500 or some other type of navigational system 500 ID) over the phone to the restaurant employee. The restaurant employee can then send an email, instant message, or other type of kind of data communication to the navigational system 500. This data communication received at the navigational system 500 can be used by the system 500 as location identifier data to query location specific information about the restaurant including generating map 304, and or directions 302 to the restaurant.

As another example and not a limitation, the restaurant employee could simply call the navigational system 500. The incoming caller ID data can suffice as the location identifier data and be used in the reverse lookup process to obtain the restaurant location specific information. Processing begins in block 1006.

In block 1006 location identifier data such as a phone number, caller ID, email address, instant message, and or other location identifier data is sent from a global network based data processing resource and received at the navigational system 500. Processing then moves to block 1008.

In block 1008 the location identifier data is used in part to perform a reverse lookup to obtain location specific information. The reverse lookup can utilize locally stored data, data on storage medium accessible by the navigational system 500 and or data remotely located accessible by way of a WAN, LAN, or other type of network connection. Such reverse lookup can include accessing global network based data processing resources. Location specific information can also be referred to as location specific data, street address, and or geographical reference point. Processing then moves to decision block 1010 shown in FIG. 4D.

Referring to FIG. 4C there is illustrated one example of a data processing device supplying location identifier data to query location specific information, the query being performed at a global network based data processing resource. In an exemplary embodiment the navigational system 500 after receiving the location identifier data may elect to data communicate with a global network based data processing resource. Such data communication can include sending the location identifier data to the remote data processing resource where the query is performed. The resulting location specific data can be formatted and or packaged for presentation and then data communicated back to the navigational system 500 for display and or presentation to the user.

In this regard, for example and not limitation the navigational system 500 can provide the location identifier data to a website or server such as GOOGLE MAPS or MAPQUEST. These websites or servers can then perform the reverse lookup query to obtain maps 304, directions 302, and other location specific information. The location specific information can be formatted and or packaged and then data communicated back to the navigational system 500 for display and or presentation to the user. Some of the advantages of this method include being able to access larger remote data processing resources, and reducing the data-handling requirements of the navigational system 500. As the system 500 would only need to display location specific information not generate the more complex maps 304, and directions 302. Processing begins in block 1030.

In block 1030 the user enters manually or by way of data communication location identifier data. Alternatively, the location identifier data such as a phone number, caller ID, email address, instant message, and or other location identifier data can be sent to and received at the navigational system 500 by way of a data processing device having direct and or indirect data communication access with the navigational system 500. Processing then moves to block 1032.

In block 1032 the location identifier data is data communicated to a global network based data processing resource where a query to produce location specific information can be performed. Such location specific information can include maps 304, directions 302, and or other location specific information. Processing then moves to block 1034.

In block 1034 the resultant location specific information is data communicated back to the navigational system 500. Optionally the system 500 can store the resultant data. Location specific information can also be referred to as location specific data, street address, and or geographical reference point. The location specific data may include data related to the surrounding area of the location, such events occurring in that locale. Processing then moves to decision block 1010 shown in FIG. 4D.

Referring to FIG. 4D there is illustrates one example of a navigational system 500 querying location specific information to be displayed, and or presented to a user. In an exemplary embodiment, after location specific identifier data has been provided to the system 500 and the reverse lookup process has obtained resultant location specific information from local and or remote data processing resources the location specific information is prepared from display to the user. In preparing the location specific information the user may have several options for displaying the information. Such options for displaying the data can include format types or styles, data filtering to provide certain subsets of the location specific information, graphical display features or options, text based display features or options, and or other types and or kinds of information display options. Many of the user preference may optionally be stored as default condition.

In addition, when a user desires to generate directions 302 to a specific location destination the user will need to provide a start location. In an exemplary embodiment, the start location may be the vehicles current GPS location. User changeable settings may make this the default condition for determining the start location. However, there could be times when the user desires to select a different start location. For example in trip planning, once the destination location is known the start location may need to be the user's house or work or some other place that the vehicle is not currently located. The ability to allow the user to select a starting location in this case could, for example and not limitation, allow the user to determine the total mileage between the start and finish destinations.

As such, processing in FIG. 4D enables the user to better interact with the queried location specific information obtained by way of the reverse query of the location identifier data provided in FIGS. 4A, 4B, and 4C. In addition, processing in FIG. 4D optionally provides the user with an option to transfer the queried location specific information to other data processing devices. Processing begins in decision block 1010.

In decision block 1010 a determination is made as to whether the user wants a map 304 displayed. If the resultant is in the affirmative that is the user wants a map 304 displayed then processing moves to block 1012. If the resultant is in the negative that is the user does not want a map 304 displayed then processing moves to decision block 1014.

In block 1012 a map 304 showing the location address is optionally displayed and or presented to the user by way of the navigational system 500. Processing then moves to decision block 1014.

In decision block 1014 a determination is made as to whether or not the user wants directions 302. If the resultant is in the affirmative that is the user wants directions 302 then processing moves to decision block 1016. If the resultant is in the negative that is the user does not want directions 302 then processing moves to block 1020.

In decision block 1016 a determination is made as to whether the start location for determining directions 302 to the destination location address is from the current GPS location. If the resultant is in the affirmative that is the current GPS location is the start location then processing moves to block 1018. If the resultant is in the negative that is the current GPS location is not to be used as the start location then processing moves to decision block 1022.

In block 1018 directions to the queried destination location address from the current vehicle GPS location are optionally determined, displayed, and or otherwise presented to the user by way of the navigational system 500. Processing moves to block 1020.

In block 1020 detailed location specific information related to the queried location identifier data is optionally displayed by the navigational system 500. Such detailed location specific information may include detailed information other then map 304 or directions 302 related to the queried reverse lookup location identifier data. In addition, optionally the user may choose to data communicate navigational system 500 data and or queried location specific information to other data processing device. Such other data processing devices can include, for example and not limitation, data processing device 202, PDA 204, wireless phone 206, and or other types and or kinds of data processing devices. Furthermore, such data communication between the navigational system 500 and the plurality of data processing devices can be by way of LAN or WAN including data communication by way of a global network 210. The routine is then exited.

In decision block 1022 a determination is made as to whether or not the start location is a previously stored location. In an exemplary embodiment for example and not limitation, the start location could be the previous destination. In this regard, once the vehicle has reached the destination location the user may elect to use this or another destination as the start location for the next trip. Optionally, the user may desire to select from a list of stored locations. If the resultant is in the affirmative that is the user wants to select a previously stored location then processing moves to block 1024. If the resultant is in the negative that is the user does not want to select a previously stored location then processing moves to block 1026.

In block 1024 the user is prompted and allowed to select a start location. Processing moves to block 1028.

In block 1026 the user is prompted to supply a start location. Such a user supplied start location could be an address, and or other data. Alternatively, the start location can be determined by the user identifying a location on the map, and or by allowing the user to determine a start location in some other way. Processing then moves to block 1028.

In block 1028 the directions 302 are determined and optionally displayed, and or otherwise presented to the user by way of the navigational system 500. Processing then moves back to block 1020.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method of determining a navigational reference location, said method comprising:
entering a plurality of location identifier data into a navigational system, the plurality of location identifier being other than a street address or a place name;
performing a reverse lookup query with said plurality of location identifier data to obtain a plurality of location specific data, said plurality of location specific data includes information associated with the location and a surrounding area; and
displaying said plurality of location specific data on said navigational system display.

2. The method in accordance with claim 1, wherein said location identifier data is a phone number.

3. The method in accordance with claim 1, wherein said location identifier data is an email address or instant message address.

4. The method in accordance with claim 1, wherein said location identifier data is a caller ID.

5. The method in accordance with claim 1, wherein said location identifier data is data communicated from a global network based data processing resource to said navigational system.

6. The method in accordance with claim 1, wherein said plurality of location specific data is a navigational reference point.

7. The method in accordance with claim 6, wherein said navigational reference point appears as a landmark reference point on a map.

8. The method in accordance with claim 1, wherein entering a plurality of location identifier data includes a user manually entering said plurality of location identifier data into said navigational system.

9. The method in accordance with claim 1, wherein entering a plurality of location identifier data includes a data processing device sending said plurality of location identifier data to said navigational system.

10. The method in accordance with claim 1, wherein entering a plurality of location identifier data is effectuated by way of voice input.

11. The method in accordance with claim 1, wherein performing a reverse lookup query includes said navigational system querying a remote global network based data processing resource.

12. The method in accordance with claim 1, wherein displaying said plurality of location specific data includes displaying or presenting a map and or a plurality of directions on said navigational system display.

13. The method in accordance with claim 1, further comprising:
communicating said plurality of location specific data to a plurality of data processing devices.

14. The method in accordance with claim 13, wherein said plurality of data processing devices includes at least one of the following:
i) a wireless phone;
ii) a personal computer;
iii) a personal data assistant (PDA); or
iv) a global network based data processing resource.

15. The method in accordance with claim 1, further comprising:
allowing a user to selectively filter content and or presentation format of said plurality of location specific data.

16. The method in accordance with claim 1, wherein said navigational system is an in-vehicle system.

17. The method in accordance with claim 1, wherein said navigational system is a handheld or portable data processing device.
